(19) United States
(12) Patent Application Publication
(10) Pub. No.: US 2008/0147929 A1
(43) Pub. Date: Jun. 19, 2008

(54) Smart device hub

(76) Inventors: Arnaud Glatron, Santa Clara, CA (US); James Lopez, Union City, CA (US); Richard E. Mellor, San Carlos, CA (US)

Correspondence Address: THE LAW OFFICE OF DEEPTI PANCHAWAGH - JAIN, C/O INTELLEVALE, PO BOX 52050, MINNEAPOLIS, MN, 55402, US

(21) Appl. No.: 11/639,592

(22) Filed: Dec. 15, 2006

(51) Int. Cl. G06F 3/00

(52) U.S. Cl. 710/63

(57) ABSTRACT

The present invention is a system and method for seamlessly and transparently combining or collectively processing different multimedia sources and/or destinations in the computer world, where such combining is independent of the application using and/or providing the multimedia data. A device in accordance with an embodiment of the present invention can accept inputs from the appliance world (e.g., with standards such as CCITT standards, SDI, NTSC, PAL, etc. or analog signals), as well as inputs from the computer world (e.g., with protocols such as USB), and communicate them cohesively to a host computer after appropriately selecting/mixing them. A device in accordance with an embodiment of the present invention can also receive signals using computer protocols from a host and appropriately route them to one or more output devices.

### BACKGROUND OF THE INVENTION

1. Field of the Invention

This invention relates generally to connection of peripheral devices to a host, and more particularly, to collectively processing streams from multiple multimedia devices connectable to a host from within another device connectable to a host.

2. Description of the Related Art

It is very common to have a setup of a computer connected to several peripherals, such as mice, keyboards, displays, Personal Digital Assistants (PDAs), webcams, microphones, speakers, headsets, and so on. Moreover, some or all of these devices may be integrated into the computer. For instance, displays are commonly integrated into laptops and PDAs. As another example, speakers and webcams are increasingly being integrated into laptops and PDAs.

Several of these devices are audio and/or video input and/or output devices. Currently, it is not possible to seamlessly switch between various available audio and/or video devices, without needing to interrupt the user experience with the device (e.g., by exiting and re-entering the application using the device). For instance, consider the scenario where a user is involved in an Instant Messaging (IM) conversation using an Instant Messaging application (such as Windows Live Messenger from Microsoft Corp. (Redmond, Wash.)). Let us say that the user is using a microphone plugged into the host for this conversation. Now let us consider that the user wants to change the conversation settings to use the microphone in his webcam, rather than the microphone plugged in to the host. Conventionally, the user will need to interrupt the on-going conversation in order to accomplish this. The user then has to re-start the conversation with the other user. This is highly inconvenient and disruptive for the user. For some other applications, the user may even need to exit the application itself and restart it in such a situation.

Another example of a user desiring to change an audio device in mid-conversation is if the user wishes to switch from a microphone and speaker connected to the host to a headset, possibly for privacy reasons. Again, such seamless switching of devices using computer protocols is not currently possible without interruption of the conversation.

Some applications may permit such changing of audio and/or video devices, but in such cases, the ability to seamlessly switch the device bus interface is dependent on the specific application used.

Selecting (or even mixing) of audio and/or video inputs and/or outputs has been done in the appliance world. For instance such mixer or crossbar devices which can receive several inputs and select one (or any combination of) these inputs. Such mixer or crossbar devices can also receive an output, and route the output to one or more outputs. Such mixers or crossbars receive inputs and provide outputs based on audio and/or video standards (and sometimes manipulate the raw analog signal directly). The devices that are connected to mixers and crossbars are not designed for use solely with a computer, as are webcams, Bluetooth headsets, other USB & FireWire devices, and such other devices that use computer protocols.

In the computer world, software mixers are available, such as one on Windows from Microsoft Corp. (Redmond, Wash.). The Windows operating system includes the audio mixer. However, this mixer is merely a set of software algorithms that aggregates and routes acquired audio data to the recording application or that mixes and routes audio data to be played on a device. Such a mixer can only manage different audio lines from and/or to a single device by controlling a crossbar or mixer in the appliance world. However, such a mixer cannot manage several different devices connected to or integrated into a host computer. Thus it is not currently possible to switch audio and video sources/destinations seamlessly using hardware in the computer world, unless these are in a single device.

There is thus a need for seamless and transparent selection/switching between different multimedia sources and/or destinations in the computer world, where such switching is independent of the application using the multimedia data. There is also a need for a device that can accept inputs with multimedia standards, as well as PC protocols (such as USB), and communicate them cohesively to the computer after appropriately selecting/mixing them.

### BRIEF SUMMARY OF THE INVENTION

The present invention is a system and method for seamlessly and transparently combining or collectively processing different multimedia sources and/or destinations in the computer world, where such combining or processing is independent of the application using and/or providing the multimedia data and done in a separate device connected to the host. In one embodiment, this separate device is connected to the host via a computer protocol.

A device in accordance with an embodiment of the present invention can accept inputs from the appliance world (e.g., with standards such as CCITT standards, SDI, NTSC, PAL, etc. or analog signals), as well as inputs from the computer world (e.g., with computer protocols such as USB), and communicate them cohesively to a host computer after appropriately selecting/mixing/processing them. A device in accordance with an embodiment of the present invention can also receive signals using computer protocols from a host and appropriately route and/or process them to one or more output devices.

Various embodiments of the present invention include different kinds of processing and mingling of the various inputs/outputs. For example, a device may composite multiple video inputs into a single 3D image, or into two side by side images in accordance with an embodiment of the present invention.

In accordance with an embodiment of the present invention, various different devices, some of which are designed for use with host computers, are plugged into a single device, which then communicates with the host using computer protocols. The user can then switch between these various devices seamlessly, without interrupting the user experience, and independent of the application using/providing the data from/to the various devices. In one embodiment, the system itself may select the appropriate input/output devices based upon optimum performance.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1 is a block diagram of a representative computer system used with multiple audio/video peripherals.

FIG. 2 is a block diagram of a device 200 which can select between multiple audio inputs and provide output to one or more different speakers.

FIG. 3 is a block diagram of an external view of a device in accordance with an embodiment of the present invention.

FIG. 4 is a block diagram of a system using device 200

FIG. 5 is a block diagram of a system in accordance with an embodiment of the present invention.

FIG. 6 is a block diagram showing some of the components of the device in accordance with an embodiment of the present invention.

FIG. 7 is a flowchart of the various steps in one embodiment of the present invention.

### DETAILED DESCRIPTION OF THE INVENTION

The figures (or drawings) depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that audio/video data is often referred to below. In fact, parts of the discussion focus on audio data alone, but this is used simply as an example. The embodiments of the present invention apply to all types of multimedia data, including, but not limited to still image data, audio data, and video data.

In the following discussion, “standards” is often used to refer to multimedia standards such as, but not limited to, SDI, standards from the CCITT, IEEE standards, video standards such as NTSC, PAL etc., and is also used to include analog audio in the appliance world (comprising, for instance, of stereos, TVs, DVD players, and so on). “Protocol” is often used to refer to protocols for computers such as USB, FireWire (IEEE 1394), other IEEE computer communication protocols, Bluetooth, RS232, wireless network protocols, wired network protocols and so on.

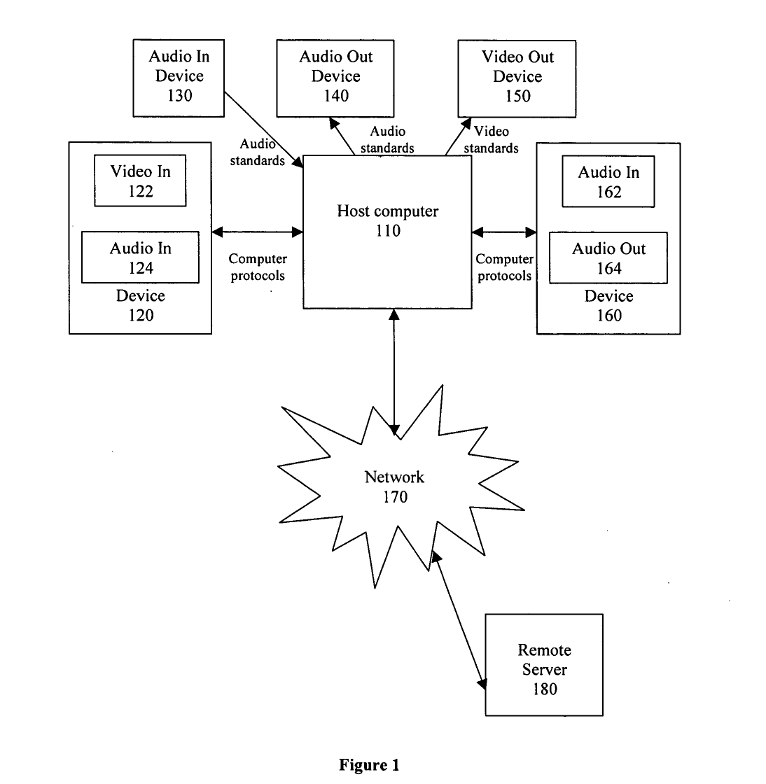

FIG. 1 is a block diagram of a representative computer system used today, with multiple audio/video peripherals. It includes the host computer 110, several audio/video in/out devices 120-160, a network 170, and a remote server 180.

In one embodiment, the host system 110 is a conventional computer system (e.g., a user's PC), that may include a computer, a storage device, a network services connection, and conventional input/output devices such as, a display, a mouse, a printer, and/or a keyboard, that may couple to a computer system. The computer also includes a conventional operating system, an input/output device, and network services software. In addition, in some embodiments, the computer includes Instant Messaging (IM) software for communicating with an IM service. The network service connection includes those hardware and software components that allow for connecting to a conventional network service. For example, the network service connection may include a connection to a telecommunications line (e.g., a dial-up, digital subscriber line (“DSL”), a T1, or a T3 communication line). The host computer, the storage device, and the network services connection, may be available from, for example, IBM Corporation (Armonk, N.Y.), Sun Microsystems, Inc. (Palo Alto, Calif.), or Hewlett-Packard, Inc. (Palo Alto, Calif.). It is to be noted that the host system 110 could be any other type of host system such as a PDA, a cell-phone, a gaming console, or any other device with appropriate processing power.

Device 120 includes a video capture module 122, as well an audio capture module 124. An example of such a device is a webcam, such as that available from Logitech, Inc. (Fremont, Calif.). Device 130 is an audio capture device, such as a microphone. Device 140 in an audio output device, such as a pair of speakers. Device 150 is a video output device, such as a display/monitor, VCR, DVD recorder, etc. Device 160 is an audio capture and output device, such as a headset. Some of these devices, such as 130, 140 and 150 communicate with the host 110 using multimedia standards described above, in which case an acquisition system must be integrated into the host for the host to receive these data stream, while other devices, such as 120 and 160 communicate with the host 110 using computer protocols, such as USB, FireWire, Bluetooth, etc.

It is to be noted that various other devices could be connected to or integrated with the host system 110, where these other devices can have capture and output capabilities for different types of multimedia data. Further, it is to be noted that any of the devices described above can be integrated with the host 110, or can be connected to the host 110 in a wired and/or wireless manner.

The network 170 can be any network, such as a Wide Area Network (WAN) or a Local Area Network (LAN), or any other network. A WAN may include the Internet, the Internet 2, and the like. A LAN may include an Intranet, which may be a network based on, for example, TCP/IP belonging to an organization accessible only by the organization's members, employees, or others with authorization. A LAN may also be a network such as, for example, Netware™ from Novell Corporation (Provo, Utah) or Windows NT from Microsoft Corporation (Redmond, Wash.). The network 170 may also include commercially available subscription-based services such as, for example, AOL from America Online, Inc. (Dulles, Va.) or MSN from Microsoft Corporation (Redmond, Wash.). The network 170 may also be a home network, a network based on the public switched telephone network, a network based on the Internet, or any other communication network. Any of the connections in the network 170 may be wired or wireless.

Remote server 180 is a remote server that the host computer 110 can communicate with over the network 170. Several other servers (not shown) may also be present.

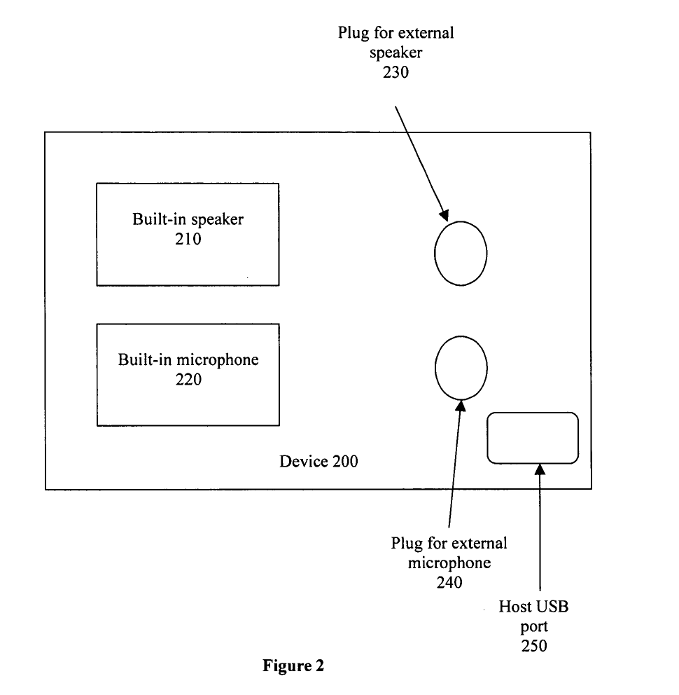

FIG. 2 is a block diagram of a device 200 which can select between multiple audio inputs and provide output to one or more different speakers.

The device 200 shown has a built-in speaker 210, and a built-in microphone 220. In addition, the device 200 has a plug 230 where an external speaker can be plugged in, as well as a plug 240, where an external microphone can be plugged in. With an external speaker and an external microphone plugged in, the device 200 will have two possible audio inputs 220 and 240, and two possible audio outputs 210 ad 230. The device 200 connects to a host 110 via host USB port 250, and can seamlessly select between the two inputs and two outputs available.

However, it can be seen that device 200 operates entirely in the audio world, using audio standards such as SDI and analog audio. It does not have any ability to deal with seamless selection between various devices which use computer protocols. For instance, devices such as webcams and headsets with USB plugs, wireless webcams and headsets communicating via Bluetooth, webcams using the FireWire port, and so on, are not connectable to device 200.

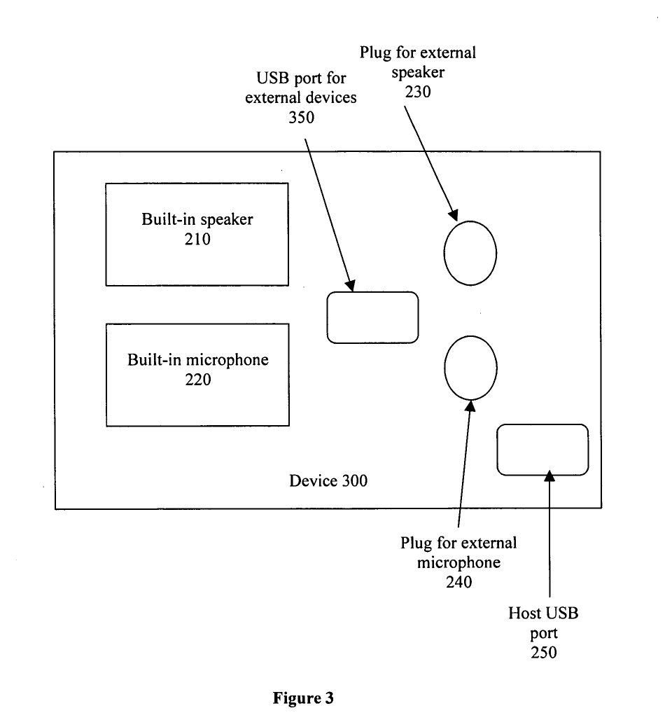

FIG. 3 is a block diagram of an external view of a device 300 in accordance with an embodiment of the present invention. Apart from a built-in speaker 210, a built-in microphone 220, a plug 230 for an external audio output device 240, a plug 240 for an external audio input device, and a host USB port 250. In addition, the device 300 also has a USB port 350 into which multimedia devices may be plugged in. It is to be noted that device 300 may have several other inputs and outputs for multimedia data, some using multimedia standards, and others using computer protocols. For example, more USB ports (not shown), one or more FireWire ports (not shown) etc. may also be included on device 300.

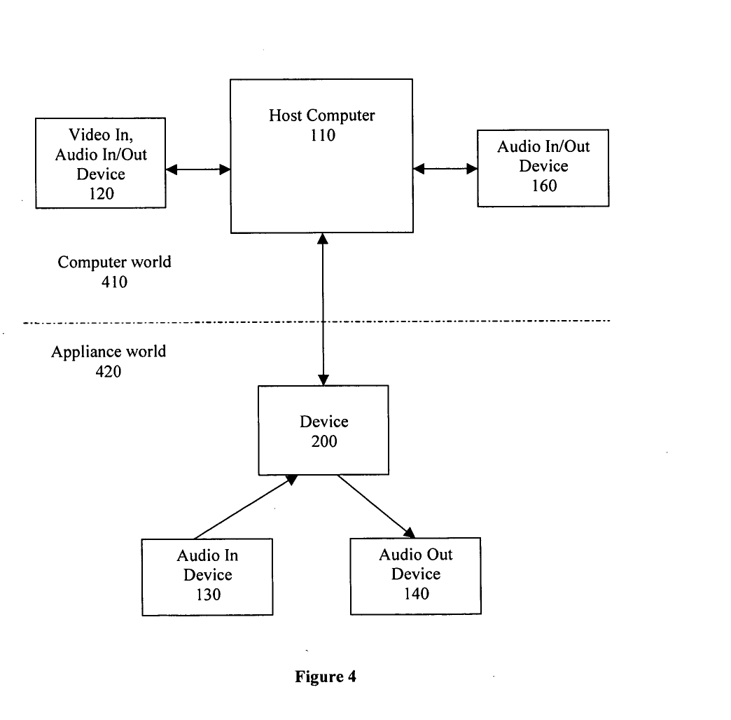

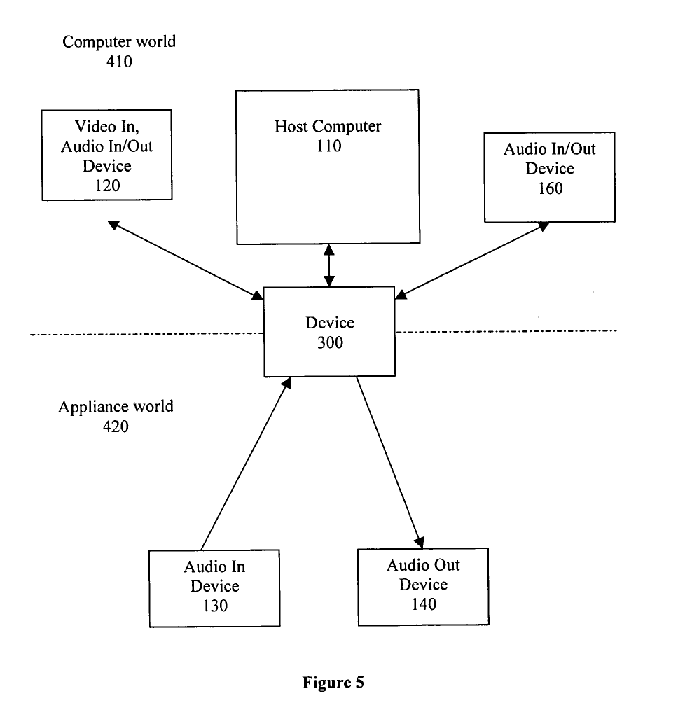

The difference between the functionality of device 200 and device 300 described above is brought out in FIGS. 4 and 5. FIG. 4 is a block diagram of a system using device 200. The system includes the host computer 110, and the devices 120, 130, 140, and 160 shown in FIG. 1, as well as device 200.

It can be seen that the host computer 110, and the devices 120 and 160 reside in the computer world 410, and communicate with each other using computer protocols. The devices 130, 140 and 200, on the other hand, reside in the appliance world 420, and communicate with each other using audio standards. In one embodiment, device 200 communicates with the host 110 through a computer protocol (USB for example). It is to be noted that here the conversion to computer protocols is done after all processing in the appliance world has been completed, just to enable the data to be transferred to the host 110.

Increasingly, the number of devices using computer protocols has grown. Such protocols provide more flexibility, allow more efficient communication of data, and so on, and as a result, several such “designed for computers” devices are very popular. As can be seen from FIG. 4, such devices 120 and 160 still need to be plugged in to the host 110 directly, and, as mentioned above, there is no way to seamlessly select between devices 120, 130, 140, and 160, independent of the application providing/using the data.

FIG. 5 is block diagram of a system in accordance with an embodiment of the present invention. Device 300 operates to seamlessly select between various devices, regardless of whether they are in the computer world 410 or the appliance world 420. As can be seen from FIG. 5, all the multimedia devices 120, 130, 140, 160 are connected to the device 300. The device 300 is then connected to the host 110. In one embodiment, the device 300 provides data to the host 110 using computer protocols. In some such embodiments, the device 300 is connected to the host 110 using USB protocols, FireWire protocols, Bluetooth protocols, etc. It is to be noted that any of the connections shown in FIG. 5 can be wired or wireless.

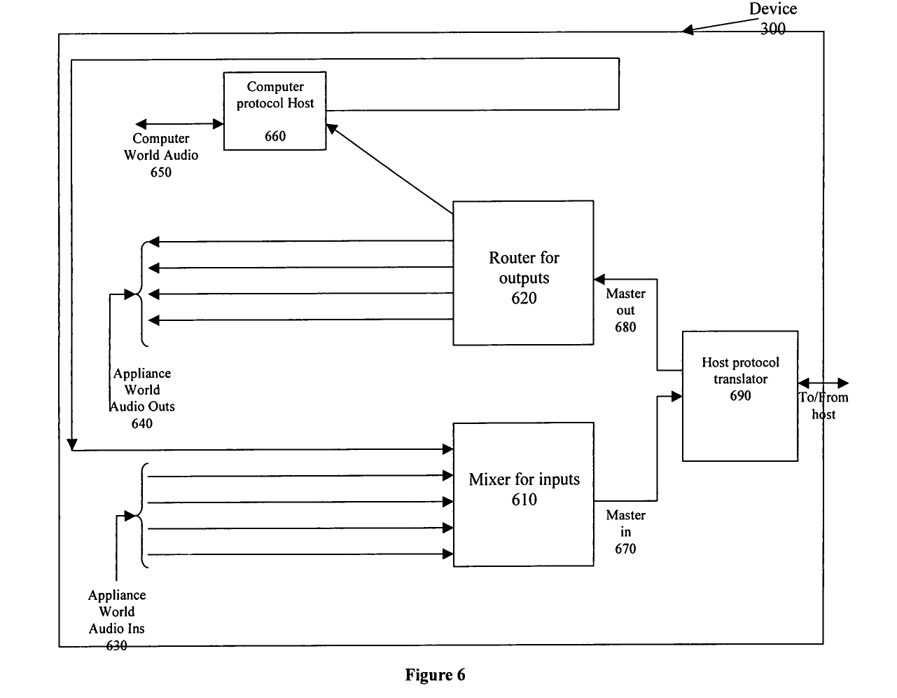

FIG. 6 is a block diagram showing some of the components of the device 300 in accordance with an embodiment of the present invention. It includes mixer 610 and router 620, appliance world audio ins 630, appliance world audio outs 640, a computer world audio 650, a computer protocol host 660, a master in 670, a master out 680, and a host protocol translator 690.

Several audio in lines 630 can come in to the device 300, from outside the device 300 (for instance, each audio line may correspond to a separate external audio in device), and/or from within the device 300 (for instance, having a built-in microphone 220 in device 300).

In addition, there may be one (or more, not shown) USB audio line 650. USB audio is bi-directional, and thus only one line is needed for the input as well as the output. An A USB host 660 is present in the device 300. This USB host 660 can be any USB host known to one of skill in the art. In one embodiment, this USB host 660 is one that can operate without a Windows (or other similar operating system) framework available on the device 300. This USB host 660 provides the necessary translation between the computer world audio line 650, and inputs and outputs in the audio world. In one embodiment, the USB host 660 is the master (in the master-slave relationship of the USB protocol), whose corresponding slave is on the audio in/out USB devices from which the computer world audio line 650 is coming. It will be obvious to one of skill in the art that more than one slave device may be present. The input provided by the USB host 660 is fed to the mixer for inputs 610, along with the other audio in lines 630. The mixer for inputs 610 then chooses one of these inputs, or any combination thereof (e.g., mixing) of these various inputs.

The output line obtained from the host 110 are input into the router 620. This router 620 then provides the output on one or more appliance world audio lines 640, and on one (or more, not shown) other audio line, which is fed into the USB host 660. The USB host 660 then appropriately converts and/or modifies the output data for providing over the USB audio line 650. Each of these audio out lines may correspond to a separate external audio out device, and/or an audio out device within the device 300 (for instance, having a built-in speaker 210 in device 300).

It can be seen that the mixer for inputs 610 provides a master in 670 which is ultimately communicated to the host 110. The mixer for outputs 620 receives a master out 670 from the host 110. In one embodiment, the master in 670 and master out 680 pass through a host protocol translator 690 before going to/from the host 110. This host protocol translator 690 translates the audio signals as appropriate, so as to communicate with the host 110 via USB. The host protocol translator 690 is the slave, whose master is on the host 110.

In other embodiments, the protocol used for this client 690 can be different from the one used in the computer protocol host 660. For instance, the computer protocol used in host 660 may be USB, while the computer protocol used in the client 690 may be Bluetooth. The communication of the device 300 with the host 110 may be wired or wireless.

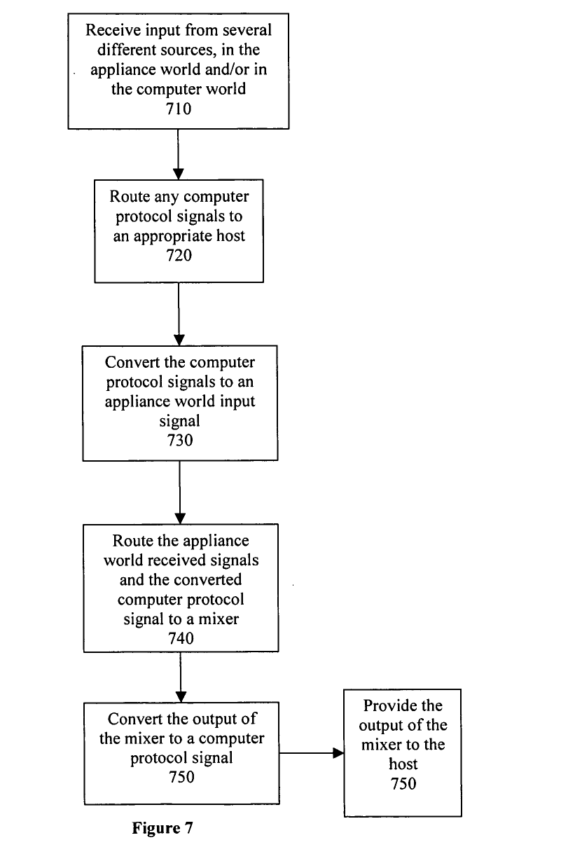

FIG. 7 is a flowchart of the various steps in one embodiment of the present invention for input signals. It will be obvious to one of skill in the art that an analogous flowchart can be created for the flow of output signals.

Several inputs are received (step 710) from audio world appliances and/or appliances ready for use with computers. Any computer protocol signals are routed (step 720) to an appropriate host. The computer protocol signals are then converted (step 730) to appliance world standards. The various appliance standard signals as well as the converted computer protocol signal are routed (step 740) to a mixer. The output of the mixer is converted (step 750) to a computer protocol. This converted output of the mixer is provided (760) to the host.

It is to be noted that while device 300 and the system including it is described above in the context of video, the present invention is not limited to audio. Rather, other types of data, such as video data and still image data, etc. can also be manipulated similarity in accordance with the embodiments of the present invention. Further, it is to be noted that the above discussion was in the context of USB protocols, but the present invention is not limited to the USB protocol. Rather, any other computer protocols could be implemented in accordance with embodiments of the present invention.

While particular embodiments and applications of the present invention have been illustrated and described, it is to be understood that the invention is not limited to the precise construction and components disclosed herein. For example, the present invention is not limited to mixing and routing of signals. Rather, any kind of processing and mingling of the various inputs/outputs can be implemented. For example, a device may composite multiple video input into a single 3D image, or into two side by side images in accordance with an embodiment of the present invention. As another example, a smart device hub may communicate with the host using multimedia standards, where the host includes an acquisition device (e.g., a video PCI board with analog or SDI inputs, an audio board with audio input jacks etc.). Various other modifications, changes, and variations which will be apparent to those skilled in the art may be made in the arrangement, operation and details of the method and apparatus of the present invention disclosed herein, without departing from the spirit and scope of the invention as defined in the following claims.

What is claimed is:

1. A device for seamless selection of multimedia inputs, wherein the device can be communicatively coupled to a host computer, the device comprising:
a first communication port for communicatively coupling the device with a first multimedia device which provides an input signal in accordance with a multimedia standard;
a second communication port for communicatively coupling with a second multimedia device which provides an input signal in accordance with a computer protocol; and
a connection means for communicatively coupling the device to the host computer.

2. The device of claim 1, further comprising:
an integrated multimedia input device.

3. The device of claim 1, further comprising:
a third connection port for communicatively couple the device with a third multimedia device which provides an output signal in accordance with a second multimedia standard.

4. The device of claim 3, wherein the third multimedia device is a speaker.

5. The device of claim 3, wherein the second multimedia standard is the same as the first multimedia standard.

6. The device of claim 1, wherein the first multimedia device is a microphone.

7. The device of claim 1, wherein the second multimedia device is a webcam.

8. The device of claim 1, wherein the second multimedia device is a headset.

9. The device of claim 1, wherein the computer protocol is USB.

10. A system for allowing a user to seamlessly switch between a plurality of multimedia devices without interrupting a communication between the user and a second user, the user using an application, wherein the application uses multimedia data provided by the devices, the system comprising:
a host on which the application resides; and
a device which is communicatively coupled to the plurality of multimedia devices, wherein the device communicatively couples with a first and a second of the plurality of multimedia devices which provide an input signal in accordance with a computer protocol,
wherein the user can switch from the first of the plurality of multimedia devices to the second of the plurality of multimedia devices without interrupting the communication, and independent of the application using the multimedia data.

11. The system of claim 10, wherein the device is communicatively coupled to the host using a second computer protocol.

12. The system of claim 11 wherein the second computer protocol is the same as the first computer protocol.

13. The system of claim 10, wherein the computer protocol is USB.

14. The system of claim 10, wherein the device is further communicatively coupled to a third of the plurality of multimedia devices which provides an input signal in accordance with a multimedia standard.

15. A device for seamless selection of multimedia inputs, wherein the device can be communicatively coupled to a host computer, the device comprising:
a mixer for receiving a plurality of multimedia inputs and providing a single input for the host computer;
a router for receiving a single multimedia output from the host computer and providing a multimedia output; and
a computer protocol host for receiving a multimedia communication using the computer protocol, wherein the computer protocol host is communicatively coupled to the mixer and the router.

16. The device of claim 15, further comprising:
a computer protocol client port for receiving the single input from the mixer and communicating it to host computer using the computer protocol.

17. The device of claim 16, wherein the computer protocol client further receives the single multimedia output from the host and provides it to the router.

18. The device of claim 15, wherein the computer protocol is USB.

19. A method for seamlessly switching between a plurality of multimedia devices without interrupting a communication between the user and a second user, the user using an application, wherein the application uses multimedia data provided by the devices, the method comprising:
receiving a plurality of multimedia inputs from a plurality of multimedia sources;
routing a first subset of the plurality of multimedia inputs to a computer protocol host;
converting the first subset to multimedia inputs using a multimedia standard;
routing a second subset of the received multimedia inputs and the converted first subset to a mixer; and
providing an output from the mixer based upon the first subset and the second subset of multimedia inputs.

20. The method of claim 19, further comprising:
converting the output of the mixer to a signal using a second computer protocol.

21. The method of claim 20, wherein the second computer protocol is the same as the first computer protocol.

22. The method of claim 20, wherein the first computer protocol is USB.
